(19) United States
(12) Patent Application Publication
(10) Pub. No.: US 2018/0312069 A1
(43) Pub. Date: Nov. 1, 2018

(54) BATTERY EXCHANGE SYSTEMS FOR UNMANNED AERIAL VEHICLES

(71) Applicant: Miasolé Hi-Tech Corp., Santa Clara, CA (US)

(72) Inventor: Robert McClymond, San Jose, CA (US)

(21) Appl. No.: 15/498,176

(22) Filed: Apr. 26, 2017

(51) Int. Cl. B60L 11/18; B64F 1/00; B64C 25/52; B60S 5/06; H02J 7/00

(52) U.S. Cl. CPC B60L 11/1822; B64F 1/00; B64C 25/52; B64C 39/024; B60S 5/06; H02J 7/0027; B60L 11/1838

(57) ABSTRACT

Disclosed are systems for exchanging batteries of an unmanned aerial vehicle (“UAV”). In some embodiments, a system may include a battery holding tube that is located on the UAV and that includes a first end with a first opening and a second end with a second opening and a battery loader configured to cause a battery to move into the battery holding tube through the first opening in a direction parallel to the center axis of the battery holding tube, wherein the center axis of the battery is parallel to the center axis of the battery holding tube, and cause the battery to move out of the battery holding tube through the second opening in a direction parallel to the center axis of the battery holding tube, wherein the center axis of the battery is parallel to the center axis of the battery holding tube.

### BACKGROUND

Battery powered unmanned aerial vehicles are used for various purposes such as photography, recreation, surveillance, military defense, and transportation of products.

### SUMMARY

In one embodiment, a system for exchanging batteries of an unmanned aerial vehicle may be provided. The system may include a battery holding tube that is located on the unmanned aerial vehicle and that includes a first end with a first opening and a second end with a second opening; and a battery loader configured to cause a cylindrical battery to move into the battery holding tube through the first opening of the first end in a direction parallel to the center axis of the battery holding tube and cause the cylindrical battery to move out of the battery holding tube through the second opening of the second end in a direction parallel to the center axis of the battery holding tube. The center axis of the cylindrical battery may be parallel to the center axis of the battery holding tube, and the center axis of the cylindrical battery may be parallel to the center axis of the battery holding tube.

In some embodiments, the system may further include an aligner that is configured to cause the battery holding tube and the battery loader to be aligned such that the center axis of the cylindrical battery is substantially coaxial with the center axis of the battery holding tube when the battery loader causes the cylindrical battery to move into the battery holding tube through the first opening of the first end in a direction parallel to the center axis of the battery holding tube.

In some such embodiments, the aligner may be further configured to cause the battery loader to move with respect to the battery holding tube to cause the battery holding tube and the battery loader to be aligned.

In some embodiments, the battery loader may be further configured to cause the cylindrical battery to move through the battery holding tube in a direction parallel to the center axis of the battery holding tube. The center axis of the cylindrical battery may be parallel to the center axis of the battery holding tube.

In some embodiments, the system may further include a landing zone configured to receive the unmanned aerial vehicle and a clamp that may be configured to fix the position of the battery holding tube with respect to the landing zone.

In some such embodiments, the system may further include a sensor configured to detect the present of an unmanned aerial vehicle in the landing zone. The battery loader may be configured to cause, when the unmanned aerial vehicle is detected in the landing zone, the cylindrical battery to move into the battery holding tube through the first opening of the first end in a direction parallel to the center axis of the battery holding tube, wherein the center axis of the cylindrical battery is parallel to the center axis of the battery holding tube.

In some embodiments, the battery holding tube may further include a first cover and a second cover. The first cover may have a first inner surface having a first electrical contact, and may be configured to be in a first open position and a first closed position. In the first open position, the first cover may not obstruct the first opening of the battery holding tube and in the first closed position, the first cover may be secured to the battery holding tube such that the first cover overlaps with the first opening when viewed along the center axis of the battery holding tube and the first electrical contact may be configured to electrically contact a cylindrical battery inside the battery holding tube. The second cover may have a second inner surface having a second electrical contact, and may be configured to be in a second open position and a second closed position. In the second open position, the second cover may not obstruct the second opening of the battery holding tube, and in the second closed position, the second cover may be secured to the battery holding tube such that the second cover overlaps with the second opening when viewed along the center axis of the battery holding tube and the second electrical contact may be configured to electrically contact a cylindrical battery inside the battery holding tube.

In some such embodiments, the system may further include a cover actuator that is configured to cause the first cover to move between the first closed position and the first open position, and cause the second cover to move between the second closed position and the second open position.

In some embodiments, the battery holding tube may be a landing skid of the unmanned aerial vehicle.

In some such embodiments, the system may further include a second battery holding tube that is another landing skid of the unmanned aerial vehicle and that includes a third end with a third opening and a fourth end with a fourth opening. The battery loader may be further configured to cause the cylindrical battery to move into the second battery holding tube through the third opening of the third end in a direction parallel to the center axis of the second battery holding tube when the center axis of the cylindrical battery is parallel to the center axis of the second battery holding tube, and cause the cylindrical battery to move out of the second battery holding tube through the fourth opening of the fourth end in a direction parallel to the center axis of the second battery holding tube when the center axis of the cylindrical battery is parallel to the center axis of the second battery holding tube.

In some embodiments, the battery loader may be configured to cause a plurality of cylindrical batteries to move into the battery holding tube through the first opening of the first end in a direction parallel to the center axis of the battery holding tube when the center axis of each of cylindrical batteries may be parallel to the center axis of the battery holding tube.

In some embodiments, the system may further include a battery storage that is configured to hold a plurality of cylindrical batteries, and a battery transporter that is configured to move a cylindrical battery from the battery storage to the battery loader.

In some such embodiments, the system may further include a battery charger configured to charge one or more cylindrical batteries, and one or more photovoltaic cells that are configured to supply power to the battery charger.

In some such embodiments, the battery charger may be further configured to charge one or more cylindrical batteries held in the battery storage.

In some such embodiments, the system may further include a battery collector that is configured to receive the cylindrical battery that is caused to move out of the battery holding tube through the second opening of the second end, and the battery transporter may be further configured to move the cylindrical battery from the battery collector to the battery charger.

In one embodiment a system may be provided. The system may include a plurality of battery exchange stations for an unmanned aerial vehicle and each battery exchange station may includes a landing zone configured to receive the unmanned aerial vehicle, a battery exchanger configured to unload batteries from and to load batteries into the unmanned aerial vehicle, a battery storage configured to store one or more batteries for the unmanned aerial vehicle, a first battery transporter configured to transport one or more batteries from the battery storage to the battery exchanger, a battery charger configured to charge one or more batteries in the battery storage, one or more photovoltaic cells configured to supply power to the battery charger, a battery receiver configured to receive batteries unloaded from the unmanned aerial vehicle, a second battery transporter configured to transport one or more batteries from the battery receiver to the battery storage, a communications mechanism configured to communicate with the unmanned aerial vehicle, and a controller configured to control the battery exchanger, the first battery transporter, the battery charger, the second battery transporter, and the communications mechanism. The controller may include control logic for causing the battery exchanger to unload batteries from an unmanned aerial vehicle in the loading zone, causing the battery exchanger to load batteries into an unmanned aerial vehicle in the loading zone, causing the first battery transporter to transport one or more batteries from the battery storage to the battery exchanger, causing the second battery transporter to transport one or more batteries from the battery collector to the battery storage, and causing the battery charger to charge one or more batteries in the battery storage.

In some embodiments, each battery exchange station may further include a sensor configured to detect whether the unmanned aerial vehicle is in the landing zone, and each controller may further include control logic for determining, based on one or more of sensor data from the sensor and communications data from the unmanned aerial vehicle, that the unmanned aerial vehicle is in the landing zone.

In some embodiments, each battery exchange station may further include a battery tracker that is configured to determine each battery loaded onto the unmanned aerial vehicle, and each controller may further include a memory and further includes control logic for storing on the memory information associated with the determination of each battery loaded onto the unmanned aerial vehicle.

In some such embodiments, the system may further include a database and each controller may further include control logic for sending to the database, using the communications mechanism, the information associated with the determination of each battery loaded onto the unmanned aerial vehicle.

In some such embodiments, each controller may further include control logic for determining the amount of charge delivered to each battery in the battery storage, and sending to the database, using the communications mechanism, information associated with the amount of charge delivered to each battery in the battery storage.

In one embodiment, a method for performing a battery exchange of a battery holding tube of an unmanned aerial vehicle may be provided. The method may include receiving instructions to perform a battery exchange of the battery holding tube on the unmanned aerial vehicle; causing, using a battery loader, a cylindrical battery to move out of the battery holding tube through a second opening of the second end of the battery holding tube in a direction parallel to the center axis of the battery holding tube, such that the center axis of the cylindrical battery is parallel to the center axis of the battery holding tube; and causing, using the battery loader, a cylindrical battery to move into the battery holding tube through a first opening of the first end of the battery holding tube in a direction parallel to the center axis of the battery holding tube, such that the center axis of the cylindrical battery is parallel to the center axis of the battery holding tube.

In some embodiments, the method may further include aligning the battery loader and the battery holding tube aligner to cause the center axis of the cylindrical battery to be substantially coaxial with the center axis of the battery holding tube when the battery loader causes the cylindrical battery to move into the battery holding tube through the first opening of the first end in a direction parallel to the center axis of the battery holding tube.

In some embodiments, the method may further include causing a first cover of the battery holding tube to move between a first closed position and a first open position, such that in the first closed position, the first cover is secured to the battery holding tube such that the first cover overlaps with the first opening when viewed along the center axis of the battery holding tube and a first electrical contact of the first cover is configured to electrically contact a cylindrical battery inside the battery holding tube, and such that in the first open position, the first cover does not obstruct the first opening of the battery holding tube; and causing a second cover of the battery holding tube to move between a second closed position and a second open position, such that in the second closed position, the second cover is secured to the battery holding tube such that the second cover overlaps with the second opening when viewed along the center axis of the battery holding tube and a second electrical contact of the second cover is configured to electrically contact a cylindrical battery inside the battery holding tube, and such that in the second open position, the second cover does not obstruct the second opening of the battery holding tube.

In some embodiments, receiving instructions to perform a battery exchange of the battery holding tube may further include receiving instructions from the unmanned aerial vehicle to perform the battery exchange.

In some embodiments, receiving instructions to perform a battery exchange of the battery holding tube may further include receiving instructions from a sensor to perform the battery exchange; the sensor may be configured to detect the presence of the unmanned aerial vehicle on a landing zone.

In some embodiments, the method may further include transporting, before causing a cylindrical battery to move out of the battery holding tube, one or more cylindrical batteries from a battery storage to the battery loader.

In some embodiments, the method may further include charging one or more cylindrical batteries in a battery storage.

In some embodiments, the method may further include receiving one or more cylindrical batteries from the battery loader, and transporting the one or more cylindrical batteries from the battery loader to a battery storage.

### BRIEF DESCRIPTION OF THE DRAWINGS

FIG. 1 depicts an off-angle view of one example implementation of a system for exchanging a battery of an unmanned aerial vehicle.

FIG. 2 depicts a side view of an example battery holding tube.

FIG. 3 depicts an off-angle view of the example battery holding tube of FIG. 2.

FIG. 4 depicts the battery holding tube of FIG. 3 with covers in closed positions.

FIG. 5 depicts a cross-sectional side view of the battery holding tube of FIG. 4.

FIG. 6 depicts a cross-sectional side view of a battery loader and a battery holding tube.

FIG. 7 depicts a cross-sectional off-angle view of the battery loader and battery holding tube of FIG. 6.

FIG. 8 depicts another cross-sectional side view of the battery loader and battery holding tube of FIG. 6.

FIG. 9 depicts another cross-sectional side view of the battery loader and battery holding tube of FIG. 6.

FIG. 10, depicts yet another cross-sectional side view of the battery loader and battery holding tube of FIG. 6.

FIG. 11 depicts another cross-sectional side view of the battery loader and battery holding tube of FIG. 6.

FIG. 12 depicts example cross-sectional areas of a battery holding tube and batteries.

FIG. 13 depicts another example battery loader and battery holding tube.

FIG. 14 depicts the example battery loader and battery holding tube of FIG. 13.

FIG. 15 depicts an example schematic of a partial battery exchange system.

FIG. 16 depicts an example system including a plurality of battery exchange stations.

FIG. 17 depicts an example battery exchange station which is similar to the battery exchange system depicted in FIG. 1.

FIG. 18 depicts a flowchart of an example technique for performing a battery exchange.

FIG. 19 depicts an example battery loading zone.

FIG. 20 depicts a cross-sectional side view of an example landing zone and clamping mechanism.

FIG. 21 depicts another example schematic of a partial battery exchange system.

FIG. 22 depicts an example loading of a battery loader.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific implementations, it will be understood that these implementations are not intended to be limiting.

There are many concepts and implementations described and illustrated herein. While certain features, attributes, and advantages of the implementations discussed herein have been described and illustrated, other implementations and their features, attributes and advantages of the present invention are apparent from the description and illustrations. As such, the below implementations are merely some possible examples of the present disclosure. They are not intended to be exhaustive or to limit the disclosure to the precise forms, techniques, materials, or configurations disclosed. Many modifications and variations are possible in light of this disclosure. It is to be understood that other implementations may be utilized and operational changes may be made without departing from the scope of the present disclosure. As such, the scope of the disclosure is not limited solely to the description below because the description of the above implementations has been presented for the purposes of illustration and description.

The present disclosure is neither limited to any single aspect nor implementation, nor to any single combination or permutation of such aspects or implementations. Moreover, each of the aspects of the present disclosure or implementations thereof may be employed alone or in combination with one or more of the other aspects or implementations thereof. For the sake of brevity, many of those permutations and combinations are not discussed or illustrated separately herein.

Unmanned aerial vehicles (hereinafter “UAVs”), which are sometimes referred to as drones, are used for a variety of purposes, such as photography and filming, surveillance by law enforcement and military, as well as the transportation of goods. For example, there is an emerging field of using UAVs, rather than traditional delivery techniques such as personal carrier delivery like the U.S. Mail, to deliver shipments and other packages ordered by consumers. Using UAVs in this manner may be advantageous over other shipment and delivery methods due to reduced operating costs, increased delivery speed, ability to travel more directly to destinations, and easier to access remote locations. However, because many UAVs are powered by batteries that necessarily have limited power, the distance that such battery-powered UAVs are able travel is correspondingly limited. Many UAVs must also have enough battery power to not only travel from their point of origin to their destination, but also to travel to another location where the UAV may acquire battery power, such a UAV battery charging station at the point of origin. For example, if a battery-powered UAV that must return to its point of origin to recharge has a total travel range of approximately 10 miles without recharging, then the UAV is limited to traveling only about 5 miles from its point of origin so that it has enough power for a return trip to its point of origin. If the UAV is to travel to more than one destination, then the allowable range from the point of origin is further diminished.

Some implementations of the present disclosure include systems for exchanging batteries of UAVs. Particular advantages of such systems may include lowering the down-time that a UAV requires to receive power and increasing the distance a battery-powered UAV may travel by eliminating the necessity of return trips to its point of origin for charging. Some implementations of the system allow the discharged batteries of UAV to be exchanged with charged batteries. This exchange may be faster and more efficient than charging the batteries of the UAV while the batteries remain in the UAV. Charging batteries of a UAV may take hours during which time the UAV is grounded and idle, while exchanging discharged batteries of a UAV with fully charged batteries may take only minutes.

Some implementations of the present disclosure include battery exchange systems that may be located along UAV travel paths. Such systems can extend the range of a UAV by allowing it to receive charged batteries along its route rather than have to return to its point of origin for recharging.

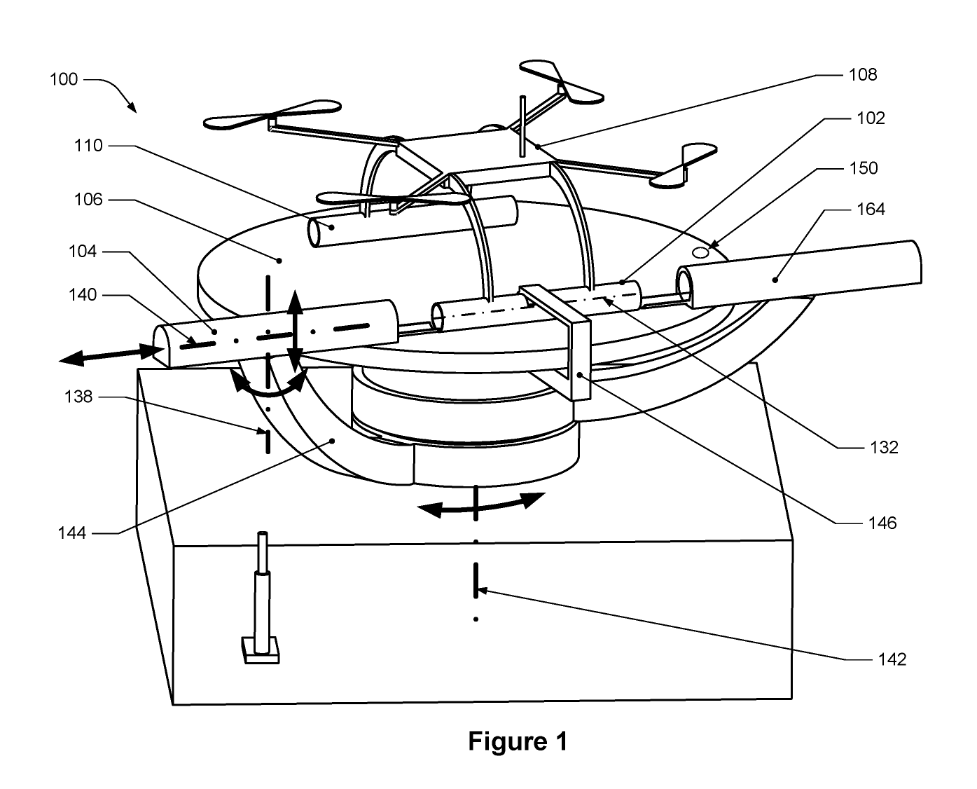

Some implementations of the systems for exchanging batteries of UAVs of the present disclosure include a battery holding tube that is located on the UAV and configured to hold one or more cylindrical batteries and a battery loader that is configured to move a cylindrical battery into the battery holding tube through one end of the battery holding tube and to move a cylindrical battery out of the other end of the battery holding tube. FIG. 1 depicts an off-angle view of one example implementation of a system for exchanging a battery of a UAV. As can be seen in FIG. 1, the example battery exchange system 100 includes a battery holding tube 102, a battery loader 104, and a landing zone 106. Other aspects of the system 100 of FIG. 1 are discussed below.

The battery holding tube 102 of FIG. 1 is located on an unmanned aerial vehicle 108, which is shown on the landing zone 106. The battery holding tube 102 may be located on various portions of the UAV, such as on its main body structure, on an arm that extends away from the main body of the UAV, or as a landing skid of the UAV 108. In the example of FIG. 1, the battery holding tube 102 functions as a landing skid of the UAV 108. As a landing skid, the battery holding tube is at the end of support arms projecting down from the main body of the UAV and is configured to support the main body. The UAV 108 may also include more than one battery holding tube 102; for example, the UAV 108 in FIG. 1 has two battery holding tubes, 102 and 110, which each act as a landing skid of the UAV 108.

Additionally, while UAV 108 is depicted as a quadcopter with four propellers, not labeled, any UAV that is configured for vertical takeoffs and landings may utilize the system of FIG. 1. In some embodiments, the landing zone 106 may be at a location on or off a runway that is flush with the ground or runway so that a UAV that is plane-like in that it requires a runway for take-offs and landings may not land directly on the landing zone 106, but rather taxi over and stop on the landing zone 106. A UAV that is configured for vertical take-offs and landings may also use such a landing zone.

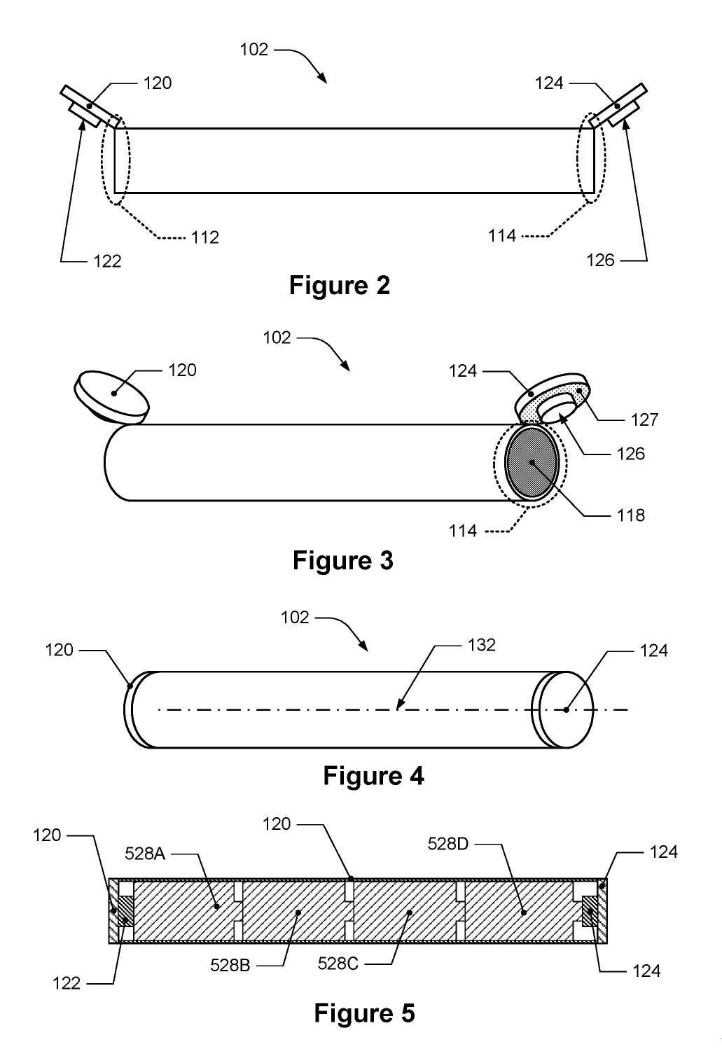

As mentioned above, the battery holding tube includes a first end and a second end. FIG. 2 depicts a side view of an example battery holding tube and FIG. 3 depicts an off-angle view of the example battery holding tube of FIG. 2. As can be seen, the battery holding tube 102 has a first end 112 and a second end 114 that is opposite the first end 112. Each end of the battery holding tube 102 also includes an opening such that the first end 112 has a first opening (not identified) and the second end 114 includes a second opening 118, which is identified in FIG. 3 with shading. The battery holding tube 102 is configured to hold one or more cylindrical batteries (not shown in FIGS. 2 or 3) and each opening of the battery holding tube 102 is configured such that the one or more cylindrical batteries may pass through each opening, as discussed in further detail below. These openings, and the inner diameter of the battery holding tube, have a substantially circular cross-sectional area (within +/−5% of round).

The battery holding tube is also configured to enable power from the batteries to be transported to the UAV. Such configuration includes electrical connections that make electrical contact with the electrical contacts of the one or more cylindrical batteries positioned inside the battery holding tube 102. For example, as can be seen in FIGS. 2 and 3, the battery holding tube 102 includes a first cover 120 with a first electrical contact 122 and a second cover 124 with a second electrical contact 126. Each electrical contact may be located on an inner surface of its corresponding cover, such as in FIG. 3 with electrical contact 126 on an inner surface 127 of the second cover 124. Each cover may be configured to move between multiple positions, such as one position that establishes electrical contact between the electrical contacts of the covers and one or more batteries positioned in the battery holding tube and securing the batteries within the battery holding tube 102, and another position that allows for the movement of cylindrical batteries through each opening of the battery holding tube. Each cover may be physically connected to the battery holding tube by, for example, a hinge-type mechanism, by threaded connections, or by magnets. For example, threads on the cover may engage with threads on the inside of the battery holding tube.

In some implementations, each cover may be configured to be placed in an open position in which each cover does not obstruct its respective opening such that a cylindrical battery may pass through the respective opening of the battery holding tube 102. Referring to FIGS. 2 and 3, the first cover 120 is in a first open position such that it does not obstruct the first opening of the first end 112 and therefore does not block or prevent a cylindrical battery from passing through the first opening of the first end 112 (e.g., into or out of the battery holding tube 102). Similarly, the second cover 122 is in a second open position such that it does not obstruct the second opening 118 of the second end 114 and thus does not block or prevent a cylindrical battery from passing through the second opening 118 of the second end 114. As noted above, the first cover 120 and the second cover 124 may be hingedly connected to the battery holding tube 102; FIGS. 2 and 3 depict the first cover 120 and the second cover 124 as connected to the battery holding tube by a hinge mechanism even though the hinge mechanism is not depicted in these Figures.

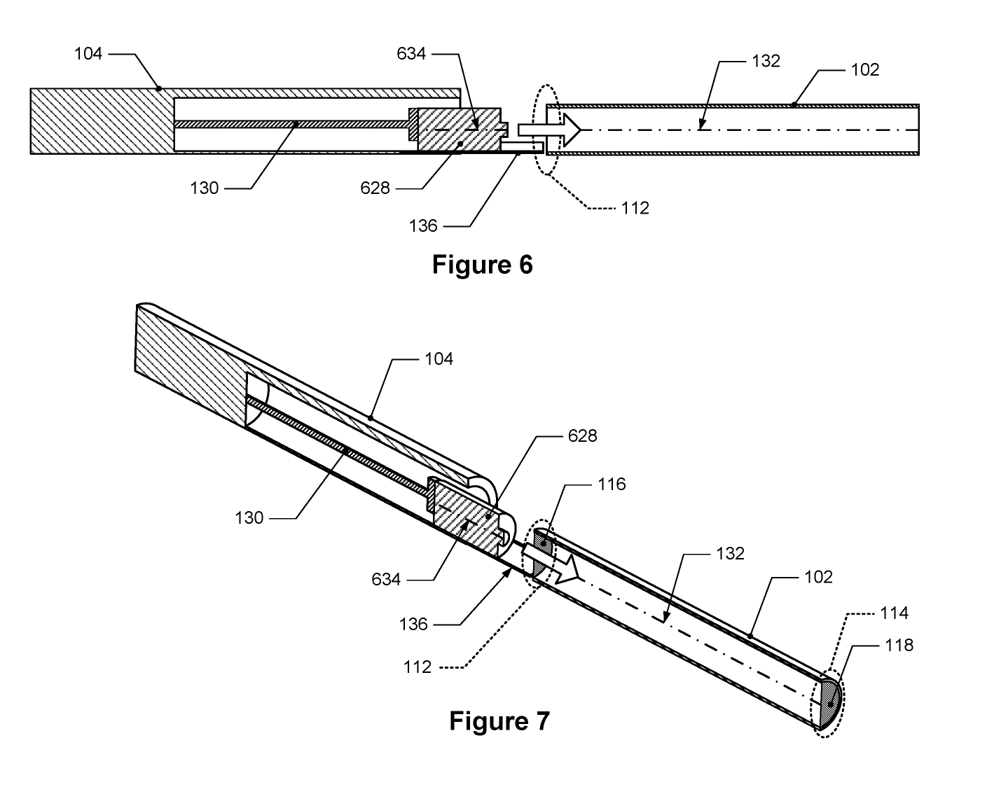

Each cover may also be configured to be placed in a closed position in which the cover is physically secured to the battery holding tube and the cover overlaps with its respective opening of the battery holding tube to cover the opening. FIG. 4 depicts the battery holding tube of FIG. 3 with both covers in closed positions. Such closed positions may enable the battery to be secured within the battery holding tube 102. As can be seen, the first cover 120 is in a first closed position and the second cover 124 is in a second closed position in which each cover is secured to the battery holding tube 102 and overlaps with its respective opening when viewed along the center axis of the battery holding tube 102. The center axis 132 is depicted in FIG. 4 as well as in FIGS. 6-11 below. Additionally, while in the first closed position, a first electrical contact (not shown) on the cover is configured to electrically contact a cylindrical battery inside the battery holding tube 102 and a second electrical contact is also configured to electrically contact a cylindrical battery inside the battery holding tube 102. FIG. 5 depicts a cross-sectional side view of the battery holding tube of FIG. 4. Here, four cylindrical batteries 528A-528D are positioned inside the battery holding tube 102, the first cover 120 is in the first closed position such that the first electrical contact 122 is in electrical contact with cylindrical battery 528A, and the second cover 124 is in the second closed position such that the second electrical contact 126 is in electrical contact with the cylindrical battery 528D. This configuration may therefore enable at least a partial electrical circuit to be made between the electrical contacts, 122 and 126, and cylindrical batteries 528A-528D positioned inside the battery holding tube 102. Additionally, the covers 120 and 124 are securing batteries 528A-528D within the battery holding tube 102.

The battery holding tube's configuration may also include the electrical wiring, features, and connections to enable electricity from the batteries to be transported from the batteries to the motors and other electrical components of the UAV.

When a UAV arrives at the example battery exchange system, the covers of the battery holding tube may be in the closed positions and the battery exchange system may be configured to cause the covers to be in their respective open positions so that a battery exchange may occur. Accordingly, the example battery exchange system may include a cover actuator that is configured to cause the first cover 120 to move between the first closed position and the first open position, and cause the second cover 124 to move between the second closed position and the second open position. The cover actuator may be a mechanism that includes multiple parts. For example, the cover actuator may include springs or pistons that are attached to each cover and a part of the battery holding tube 102 and configured to mechanically cause (e.g., using the spring or piston energy) each cover to move between positions; this example cover actuator mechanism may be well-suited for covers that are hingedly connected to the battery holding tube. Additionally, for covers that are connected to the battery holding tube using a threads, the cover actuator may be a mechanism that is configured to screw or unscrew the cover from the battery holding tube and move each cover away from the battery holding tube such that a cylindrical battery may be moved through each end of the battery holding tube.

Referring back to FIG. 1, the battery exchange system 100 includes the battery loader 104 that is configured to move batteries into and out of the battery holding tube 102 as illustrated in FIGS. 6-11. The movement of batteries into the battery holding tube 102 is referred to as the “loading” of batteries while the movement of batteries out of the battery holding tube 102 is referred to as the “unloading” of batteries. In some implementations, the battery loader is configured to load a battery into the battery holding tube by causing a cylindrical battery to move into the battery holding tube through the first opening of the first end in a direction parallel to the center axis of the battery holding tube while the center axis of the cylindrical battery is parallel to the center axis of the battery holding tube. Such a battery loader is also configured to unload a battery from the battery holding tube by causing the cylindrical battery to move out of the battery holding tube through the second opening of the second end in a direction parallel to the center axis of the battery holding tube while the center axis of the cylindrical battery is parallel to the center axis of the battery holding tube. In these implementations, the movement of a cylindrical battery into, through, and out of the battery holding tube is performed in a linear translation motion along the center axis of the battery holding tube while one or both openings of the battery holding tube are open. A cylindrical battery may move into the battery holding tube through one opening and a cylindrical battery may move out of the battery holding tube through the other opening. A linear push motion may be used to push out one or more discharged batteries while loading one or more charged batteries. Both ends of the battery tube remain open. In alternate embodiments, one end of the battery holding tube is closed while a battery is unloaded by a pull motion out of the other end of the battery holding tube. A charged battery may be loaded into the battery holding tube through either end as appropriate.

FIG. 6 depicts a cross-sectional side view of a battery loader and a battery holding tube while FIG. 7 depicts a cross-sectional off-angle view of the battery loader and battery holding tube of FIG. 6. As can be seen, the battery loader 104 includes a battery loading mechanism, which is a piston 130 here, that is configured to push a cylindrical battery 628 out of the battery loader 104 and into the battery holding tube 102 through the first opening of the first end 112. In FIG. 7, the first opening 116 and the second opening 118 of the battery holding tube 102 are identified with shading. The indicated movement of the cylindrical battery 628 is in a direction parallel to the center axis 132 of the battery holding tube 102 as illustrated by the arrow in FIG. 6, and during this movement, the center axis 634 of the cylindrical battery 628 is parallel to the center axis 132 of the battery holding tube 102. The center axes of the battery holding tube 102 and cylindrical battery 628, 132 and 634, respectively, are therefore parallel to each other during the movement of the cylindrical battery 128 into and through the battery holding tube 102.

In some implementations, the battery loader 104 and the battery holding tube 102 may not be perfectly aligned during some of the movement of the cylindrical battery 628 through the first opening of the battery holding tube 102. It is therefore contemplated that in some implementations, the battery loader 104 is configured to cause the cylindrical battery 628 to move into the battery holding tube 102 through the first opening of the first end 112 in a direction substantially parallel to the center axis 132 of the battery holding tube, e.g., within +/−5% of parallel from each other, while the center axis 634 of the cylindrical battery 628 may also be substantially parallel to the center axis 132 of the battery holding tube 102, e.g., within +/−5% of parallel from each other.

Additionally, in some implementations, the center axis 132 of the battery holding tube 102 and the center axis 634 of the cylindrical battery 628 may be substantially coaxial, e.g., within +/−10% of coaxial with each other, during some or all of the movement into and/or through the battery holding tube 102. For the cylindrical battery 628 to be able to move into and through the battery holding tube 102, the inner diameter of the battery holding tube 102 is sized larger than the outer diameter of the cylindrical battery 628 and such spacing may cause the center axes of the cylindrical battery 628 and the battery holding tube 102 to be substantially coaxial. Here, the axes may not be coaxial in various manners, such as they may not be parallel with each other or may be offset from each other by a distance or both.

In some implementations, like that depicted in FIGS. 6 and 7, the battery loader 104 may also include a slide 136 that enables the cylindrical battery 628 to travel from the battery loader 104 to the battery holding tube 102 in situations in which there is a gap between the battery loader 104 and the battery holding tube 102. The slide 136 may be moveable such that it is configured to extend from and retract into the battery loader 104 in order to account for varying distances between the battery loader 104 and the battery holding tube 102.

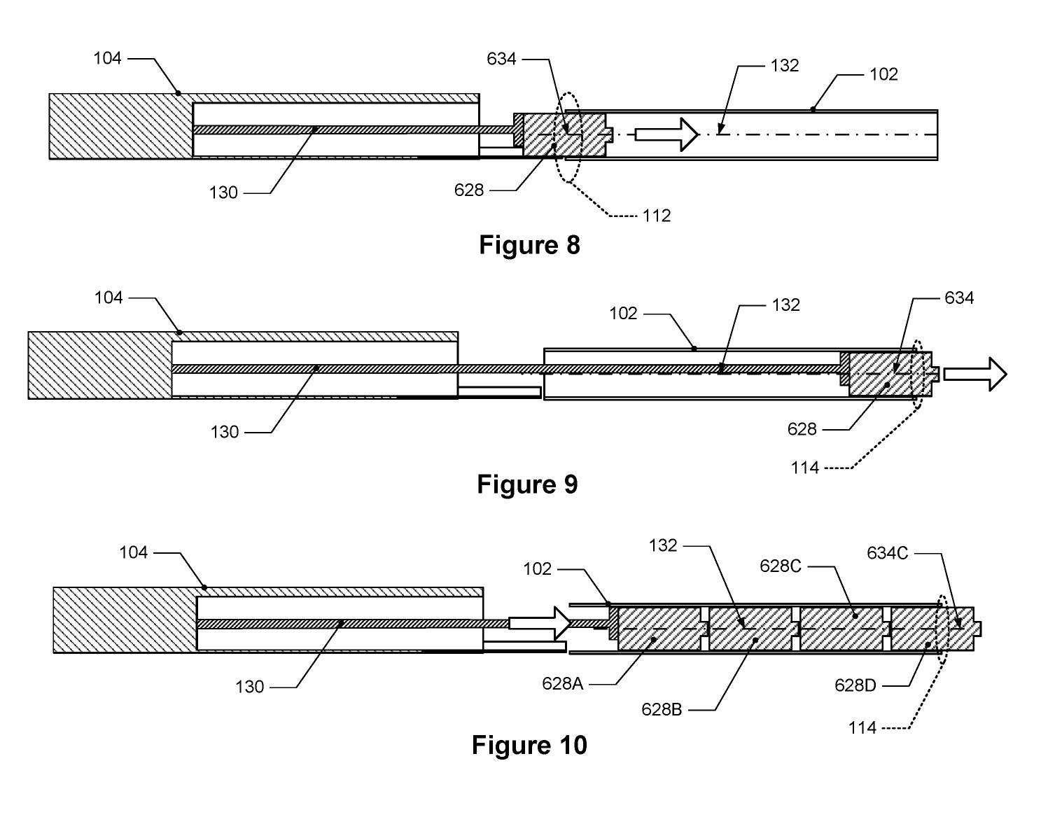

The battery loader 104 may also be configured to cause the cylindrical battery 628 to move through the battery holding tube 102 in a direction parallel to the center axis 132 of the battery holding tube 102, and during this movement, like above, the center axis 634 of the cylindrical battery 628 is parallel to the center axis 132 of the battery holding tube 102. This movement may be seen in FIG. 8 which depicts another cross-sectional side view of the battery loader and battery holding tube of FIG. 6. Here in FIG. 8, the battery loader 104 is causing the cylindrical battery 628 to move through the battery holding tube 102 in a direction parallel to the center axis 132 of the battery holding tube 102 as indicated by the arrow. Moreover, the center axis 132 of the battery holding tube 102 is parallel to and coaxial with the center axis 634 of the cylindrical battery 628. As stated above, in some implementations, the center axis 132 of the battery holding tube 102 may be substantially parallel to, e.g. within +/−5% of parallel, and/or coaxial with, e.g., within +/−10% of coaxial, the center axis 634 of the cylindrical battery 628. This configuration of the battery loader 104 provides the ability to move cylindrical batteries through the battery holding tube 102 that were previously located in the battery holding tube, i.e., unloading batteries from the battery holding tube 102, and the configuration also includes the ability to move a battery through the battery holding tube after its movement into and through the first opening of the first end, i.e., loading batteries into the battery holding tube 102.

As stated above, the battery loader is also configured to unload a battery from the battery holding tube. Such unloading configurations may vary with example configurations discussed in FIGS. 9-11. For instance, FIG. 9 depicts another cross-sectional side view of the battery loader and battery holding tube of FIG. 6 and as can be seen, the piston 130 is directly contacting and moving, i.e., pushing, one cylindrical battery 628 out of the second opening of the second end 114 of the battery holding tube 102. In FIG. 10, which depicts another cross-sectional side view of the battery loader and battery holding tube of FIG. 6, the battery loader 104 is causing multiple cylindrical batteries to move out of the second opening of the second end by having the piston 130 directly contacting and moving, i.e., pushing, one cylindrical battery 628A which in turn pushes the other cylindrical batteries 628B-628D, respectively, out of the second opening of the second end 114 of the battery holding tube 102.

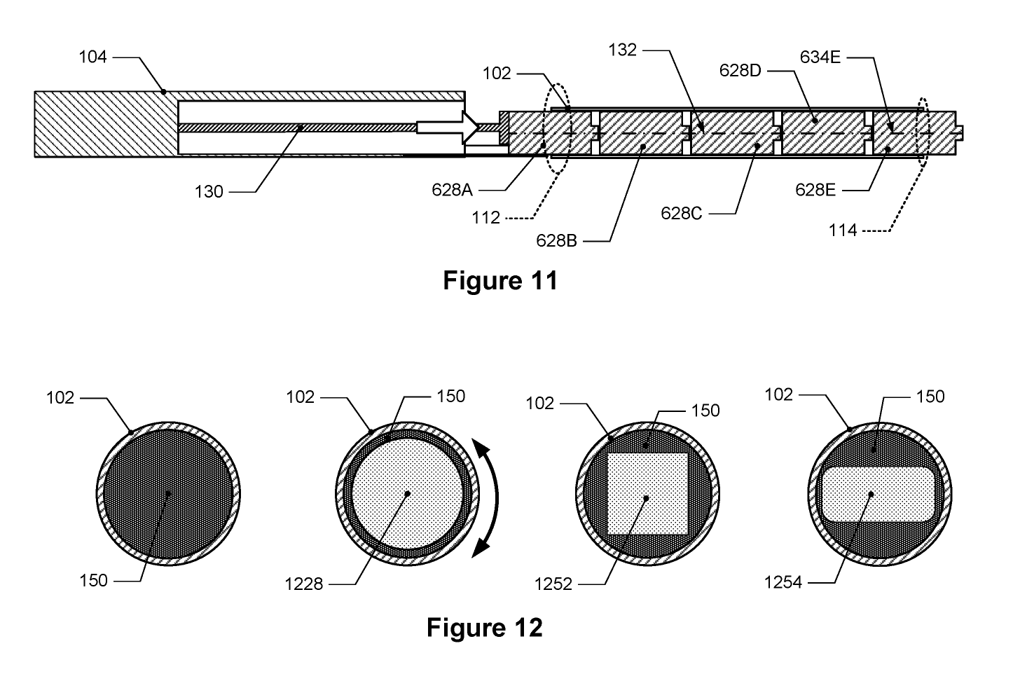

Similar to FIG. 10, the battery loader 104 may be configured to cause the simultaneous loading and unloading of batteries into and out of the battery holding tube 102. Before the loading and unloading, the battery holding tube typically contains batteries (e.g., batteries that are completely or partially discharged) that are to be unloaded. The battery loader may cause the new, fresh batteries to be loaded into the battery holding tube which in turn contact, and push out the old batteries out of the battery holding tube thereby unloading the old batteries. This simultaneous loading and unloading of batteries is illustrated by FIG. 11 which depicts another cross-sectional side view of the battery loader and battery holding tube of FIG. 6. Here, for instance, battery loader 104 is loading cylindrical battery 628A into and through the first end 112 of the battery holding cylinder 102 which in turn simultaneously unloads cylindrical batteries 628B-628E out of the second opening of the second end 114.

The movement of the cylindrical batteries in FIGS. 9-11 is like that of FIG. 8 in which the cylindrical batteries move in a direction parallel to the center axis 132 of the battery holding tube 102 while the center axis 634 of each cylindrical battery is parallel to the center axis 132 of the battery holding tube 102.

According to various implementations, the battery holding tube may be configured to load one battery at a time into the battery holding tube (like in FIG. 8), to load multiple batteries at one time into the battery holding tube (like in FIG. 10 if batteries 628A, 628B, and 628C are being loaded into the battery holding tube 102), to unload one battery at a time out of the battery holding tube (like in FIG. 9), to unload multiple batteries at one time out of the battery holding tube (like in FIG. 10 described above), and to load one or more batteries into the battery holding tube while simultaneously unloading one or more batteries out of the battery holding tube (like in FIG. 11 if cylindrical batteries 628A and 628B are being loaded while cylindrical batteries 628C-628E are simultaneously being unloaded).

In some implementations, such as those discussed above in FIGS. 6-11, the system uses a cylindrical battery holding tube and cylindrical batteries that are sized to fit end to end within the cylindrical battery holding tube. The diameter of the outer cylindrical surface of the cylindrical batteries to be inserted into the battery holding tube is sized less than the diameter of the internal tubular surface of the battery holding tube which enables the cylindrical batteries to be inserted into the battery holding tube. The diameter of the outer cylindrical surface of the cylindrical batteries may vary such that a gap of varying size may exist between the cylindrical surface of the cylindrical batteries and the internal tubular surface of the battery holding tube. Additionally, the use of these shapes enables the cylindrical batteries to be loaded into the battery holding tube with limited alignment issues and complexities. While alignment of the battery loader and the battery holding tube may be performed as described below, no rotational alignment of the cylindrical battery about its cylindrical axis is necessary. This is because the cross-sectional area of the cylindrical battery, viewed along its center axis (e.g., center axis 634 of FIG. 6), and the cross-sectional area of internal tubular surface of the battery holding tube, viewed along its center axis (e.g., center axis 132 of FIG. 6) are both circular or substantially circular and rotationally aligned. Substantially circular refers to a nominally circular cross-section within +/−5% of round.

Additionally, in some other implementations, batteries with non-circular cross-sectional shapes may be used in conjunction with a battery holding tube having an internal circular cross-sectional area. In such implementations, the boundary of the cross-sectional area of each battery fits within the internal circular cross-sectional area of the battery holding tube. For example, FIG. 12 depicts example cross-sectional areas of a battery holding tube and batteries. The view of FIG. 12 is along the center axis (not shown) of the battery holding tube 102 which is perpendicular to the page. As can be seen, the battery holding tube 102 has a circular cross-sectional area 150 shown in dark cross-hatching, cylindrical battery 1228 having a circular cross-section area is located within battery holding tube 102, battery 1252 having a square cross-sectional area is located within battery holding tube 102 with the perimeter of this square cross-sectional area fitting within the inner circular cross-sectional area 150 of the battery holding tube 102, and battery 1254 having a rectangular cross-sectional area is similarly located within battery holding tube 102. As mentioned above, no rotation of the cylindrical battery 1228 is needed about its center axis (perpendicular to the page) line in the direction of the arrows on the outside of battery holding tube 102 second from the left in FIG. 12. Similarly, no rotation of batteries 1252 and 1254 are needed about their center axes.

If the cross-sectional areas of the battery and the battery holding tube are both non-circular shapes, such as a square, then rotation of the battery about its center axis may be necessary so that its non-circular cross-sectional area is aligned with the non-circular cross-sectional area of the battery holding tube. For example, a tube with a square cross-section and a battery also having a square cross-section must be aligned such that the respective square cross-sections match each other.

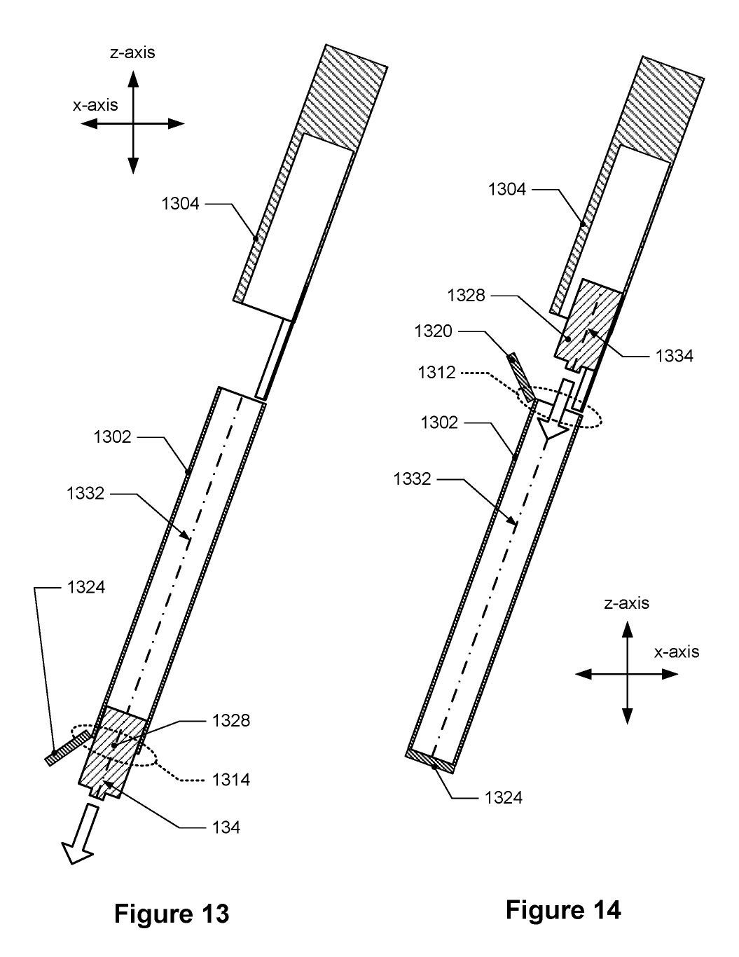

In another embodiment of the present disclosure, the battery holding tube may be oriented at a vertical angle, or at least a partially vertically angle, during the loading and unloading of batteries from the battery holding tube. FIG. 13 depicts another example battery loader and battery holding tube. As can be seen in FIG. 13, the battery holding tube 1302 is oriented in a partially vertical position such that its center axis 1332 has a component in the vertical direction, or z-axis; in some implementations this may mean that the center axis 1332 is not parallel to the landing zone. The z-axis may be considered perpendicular to the landing zone (not shown) which may be co-planar with the x-axis of FIG. 13. In some embodiments, the battery holding tube 1302 may be vertical such that its center axis 1332 is substantially parallel (within +/−10% of parallel) to the z-axis. When the battery holding tube 1302 is oriented in such a manner, the batteries located within the battery holding tube may be caused to move out of the second opening (not shown) of the second end 1314 of the battery holding tube 1302 due to gravity. The battery loader 1304 may be configured to cause this movement, i.e., unloading, by causing the second cover 1324 of the battery holding tube 1302 to open or move to the second open position as discussed above. Once the second cover is in the second open position, the batteries 1328 may be able to move out of the battery holding tube 1302 in the direction indicated by the arrow. In some such implementations, the battery loader 1304 may not directly physically contact and move the battery 1528 out of the second end 1314 of the battery holding tube 1302 while in others, the battery loader 1304 may contact and cause the batteries to move. Additionally, during this unloading, the first cover (not shown) may or may not be in the first open position.

During loading, the battery loader 1304 is configured to cause the batteries located in the battery loader 1304 to move through the first opening of the first end 1314 of the battery holding tube 1302 and into the battery holding tube 1302, which may be due to gravity. FIG. 14 depicts the example battery loader and battery holding tube of FIG. 13. Again, like discussed above and can be seen in FIG. 14, the battery loader 1304 is configured to be aligned with the battery loading tube 1302, for instance aligned such that the cylindrical battery 1328 may move into the battery holding tube 1302 through the first opening of the first end 1312 in a direction parallel to the center axis 1332 of the battery holding tube 1302 while the center axis 1334 of the cylindrical battery 1328 is parallel to the center axis 1332 of the battery holding tube 1302. Here, the battery 1328 may move into and through the first end 1312 of battery holding tube 1302 in the direction of the arrow under the force of gravity. The battery loader 1304 may have a release mechanism that is able to secure the battery 1328 from falling, but upon activation, causes one or more batteries 1328 to move, e.g., fall, into the battery holding tube 1302. During this loading process, the first cover 1320 is in the first open position while the second cover 1324 is in the second closed position such that the batteries in the battery holding tube 1302 do not fall out of the battery holding tube 1302.

When a UAV arrives at the landing zone, the battery loader and the battery holding tube of the UAV may not be aligned with each other. For instance, some UAVs may only have a landing accuracy of 3 to 30 feet and the landing zone of the system may be sized to accommodate differing landing accuracies of the UAVs, such as 6 feet by 6 feet. In some implementations, the battery exchange system may therefore include an aligner that is configured to cause the battery loader to be aligned such that the battery loader may load and unload batteries into and from a battery holding tube. This alignment may include the alignment of the center axis of the cylindrical battery that is to be loaded into the battery holding tube so that it is parallel to the center axis of the battery holding tube and substantially coaxial (within 10% of coaxial alignment) with the center axis of the battery holding tube. This alignment may also be considered as the alignment of the outer cylindrical surface of the cylindrical battery that is to be loaded into the battery holding tube so that it is concentric with the inner cylindrical surface of the battery holding tube.

Such alignment may be achieved by having one or both of the battery loader and the battery holding tube move in various directions. The movements may include one or both of rotational movements about one or more rotational axes that are perpendicular to the center axis of the battery holding tube and linear movements. For example, referring back to FIG. 1, the aligner (not identified) of the battery exchange system 100 is configured to cause battery loader 104 to move linearly along and rotationally about axis 138 which may be perpendicular to the landing zone 106 or perpendicular to the center axis 132 of the battery holding tube 102, as well as linearly along another axis 140 which is perpendicular to axis 138; these movements are indicated by the three solid arrows near the battery loader 104 in FIG. 1. The aligner of the battery exchange system is also configured to cause the battery loader 104 to rotate about another axis 140. The aligner here may include the elements and mechanisms necessary to achieve such alignment, such as a support arm 144, motors, gears, sockets, and pins.

In some other implementations, the aligner may be configured to cause the UAV to move so that it is aligned with the battery loader. This may include moving the UAV on or about one or more axes of movement. In some such implementations, the aligner may be configured to cause both the battery holding tube and the battery loader to become aligned with each other.

In some implementations, as noted above, the landing zone may be configured to receive the UAV such that a suitable surface, or surfaces, supports the UAV. For example, as can be seen in FIG. 1, the landing zone 106 is a flat, planar surface that has a diameter large enough to support the UAV structure. In some implementations, the system is configured to perform a battery exchange while the UAV is located on the landing zone while in some other implementations, the system may include a landing zone and a separate battery loading zone such that UAVs land onto the landing zone and batteries are exchanged on the battery loading zone.

In some implementations, the battery exchange system may include one or more clamps that are configured to fix the position of the battery holding tube with respect to the landing zone or battery loading zone, thereby preventing the battery holding tube from moving during battery unloading and loading. For example, in FIG. 1 a clamp 146 is configured to secure the battery holding tube 102 with respect to the landing zone 106. Clamp 146 includes a semi-circular surface that is configured to contact the battery holding tube 102. Clamp 146 may also be configured to move in various directions and along various rotational axes similar to the battery loader 104 described above, such as linearly along and rotationally about axis 142 (which is perpendicular to the landing zone 106) and linearly along an axis perpendicular to axis 142. Clamp 146 is an illustrative example of a clamp and the configurations of the one or more clamps may vary.

Another example of the clamp includes one or more magnets located underneath the landing zone or battery loading zone that are configured to secure the UAV using magnetic forces. FIG. 20 depicts a cross-sectional side view of an example landing zone and clamping mechanism. As can be seen, a plurality of magnets 20108 are located below the landing zone 2006 and function as the clamp. When a UAV lands on the landing zone 2006, the magnets 20108 are configured to engage with corresponding magnetic surfaces on the UAV, such as other magnets or magnetic materials on the UAV; the landing zone is also configured so that it is thin enough for the magnetic forces of the magnets 20108 to reach the UAV located on the landing zone 2006. The plurality of magnets 20108 may be configured to be moveable, as indicated by the vertical double-ended arrow, so that the magnets may be moved away from the surface of the landing zone 2006 in order to prevent the magnetic forces of the magnets 20108 from engaging with the UAV. This movement allows the UAV to be movable on, around, and from the landing zone, and also to be secured to the landing zone, such as during inclement weather or a battery exchange. The configuration of FIG. 20 is also applicable to the battery loading zone.

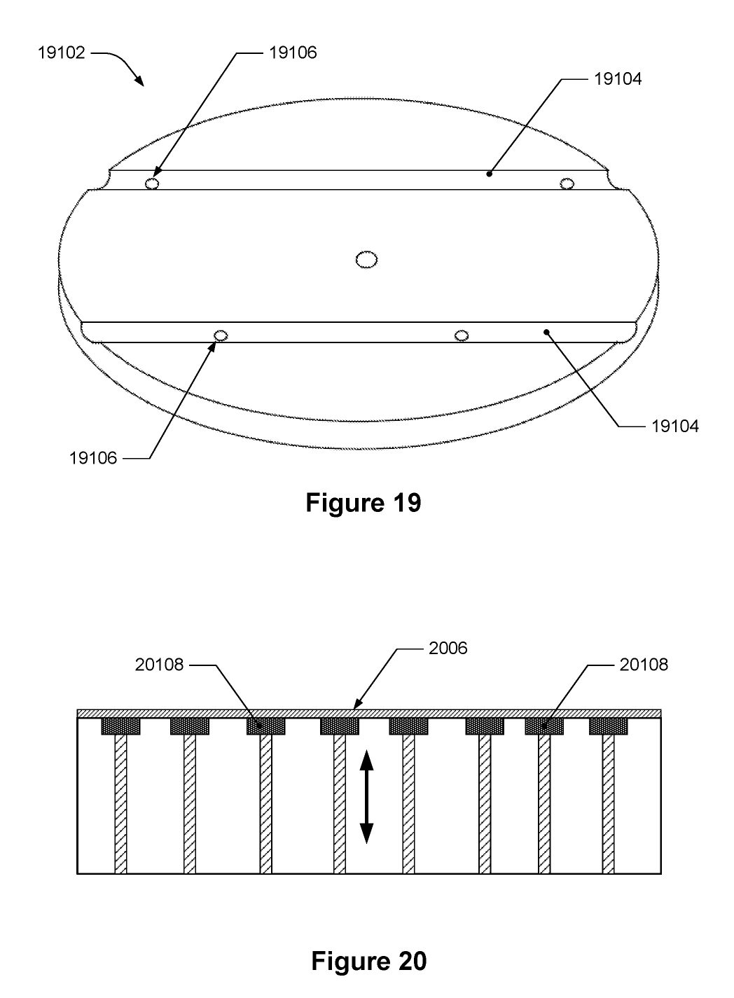

In some of the implementations that include a landing zone and a separate battery loading zone, the landing zone may be dedicated only to UAV landings. In some such implementations, the UAV may land on the landing zone and then be moved to the battery loading zone by a robotic mechanism, such as a robotic arm (e.g., a pick-and-place robotic arm), or by a person. The battery loading zone may be a structure that is configured to support a UAV during a battery exchange, like those exchanges described herein. This configuration may include a support surface as well as alignment features, such as, grooves, channels, slots, or orifices that are configured to engage with features on the UAV. For example, FIG. 19 depicts an example battery loading zone. As can be seen, the battery loading zone 19102 includes two semi-circular channels 19104 that are configured to receive and support a battery holding tube of a UAV and four holes 19106 that are configured to receive pins or other alignment features located on the battery holding tube.

The battery exchange system may also include various sensors which may be used to detect the presence of a UAV near or on the landing zone, used by the aligner during the alignment process of the battery loader and the battery holding tube, and used by the clamp. For example, to detect the presence of a UAV on the landing zone various sensors and detectors may be used (such as a sensor 150 on landing zone 106 in FIG. 1), such as a pressure sensor on the landing zone, an RFID reader, a thermal radiation sensor, one or more cameras, or one or more lasers. Additionally, the system may be further configured to detect, using the sensors, whether a UAV is located on the landing zone; if the UAV is detected on the landing zone then the system may be configured to perform the loading and unloading of the battery holding tube of that UAV after such detection. For the alignment process, for instance, lasers and other locational sensors may be used so that the system may detect the location and orientation of the battery holding tube and therefore move the battery loader into alignment with the battery holding tube.

In some implementations, the system may also be configured to detect a UAV near the landing zone, for instance, sensors, as well as other communications devices, such as short wave radios, RFID, infrared or visual light transmitters and sensors (e.g., a central flashing light of a known frequency and lights of either a known color or known flashing such as a 100 Hz flashing red and a 30 Hz flashing green light), satellite communications, Bluetooth, radar, etc., may be used so that the UAV and the system may communicate with each other and a UAV may alert the system that the UAV is approaching and a battery exchange is to be performed. These communications devices may also enable the UAV to be identified by the system, may provide landing guidance as well as landing conditions of the landing zone, such as wind and temperature, and may communicate to the UAV that it is secured to a landing zone and that a battery exchange has occurred and the UAV may leave the landing zone.

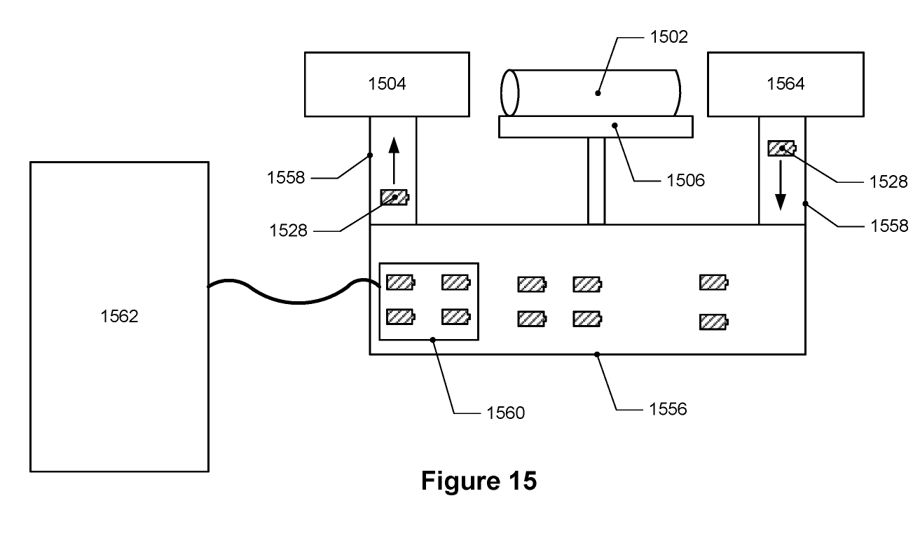

In some embodiments, the battery exchange system may also include at least one of a battery storage, a battery transporter, a battery charger, a photovoltaic cell, and a battery collector. FIG. 15 depicts an example schematic of a partial battery exchange system; FIG. 15 is intended to be an illustrative representation of some aspects of the subject system. As can be seen, the system includes battery holding tube 1502 which is located on the landing zone 1506, battery loader 1504, battery storage 1556, battery transporter 1558, battery charger 1560, photovoltaic cell 1562, and battery collector 1564. The battery storage 1556 is configured to contain and store one or more batteries that may be loaded into the battery holding tube 1502 by the battery loader 1504. The battery storage may be configured to store multiple types and sizes of batteries as well as configured to detect the type of battery that is compatible and suitable (e.g., correct size and voltage) for the battery holding tube of the UAV that is located on the landing zone and load the compatible battery into the battery holding tube of that UAV.

The battery transporter 1558 is configured to transport one or more batteries from the battery storage 1556 to the battery loader 1504 as indicated in FIG. 15 by the representational battery 1528 and the directional arrow in the battery transporter 1558. The battery transporter 1558 may include various mechanisms and features that enable it to select and transport one or more batteries to the battery loader 1504, such as an elevator, belt fed transportation system, or selector arm.

The battery collector 1564 is configured to receive one or more of the batteries that are unloaded out of the battery holding tube 1502. Such battery collector may be configured in various ways and may be a hole or slot, basket, catcher, a cylinder, or an identical, duplicate battery loader which is configured to not only load, but also to receive batteries. Referring back to FIG. 1, system 100 includes a battery collector 164 that is configured to receive batteries that unloaded. This battery collector 164 is similar to battery loader 104 described above in that it includes slide 136 and is configured in a similar manner to have batteries move through its tube in a direction parallel to its center axis. The battery transporter 1558 may also be configured to move the battery 1528 from the battery collector 1564 to the battery storage 1556, as indicated in FIG. 15. The battery collector 1564 may also be configured to be aligned with the battery holding tube 102 such that the battery collector 1564 may receive batteries that are unloaded from the battery holding tube 102. This alignment may occur like discussed herein above.

The battery charger 1560 is configured to charge one or more of the batteries of the system. In some embodiments, such as that shown in FIG. 15, the battery charger 1560 is configured to charge one or more batteries held in the battery storage 1556. The battery charger 1560 may include the electrical contacts, inverters, and other electrical components that are necessary to charge batteries. The battery charger 1560 may receive its electricity from various sources, such as one or more photovoltaic cells 1562, a wind turbine, battery, or power grid.

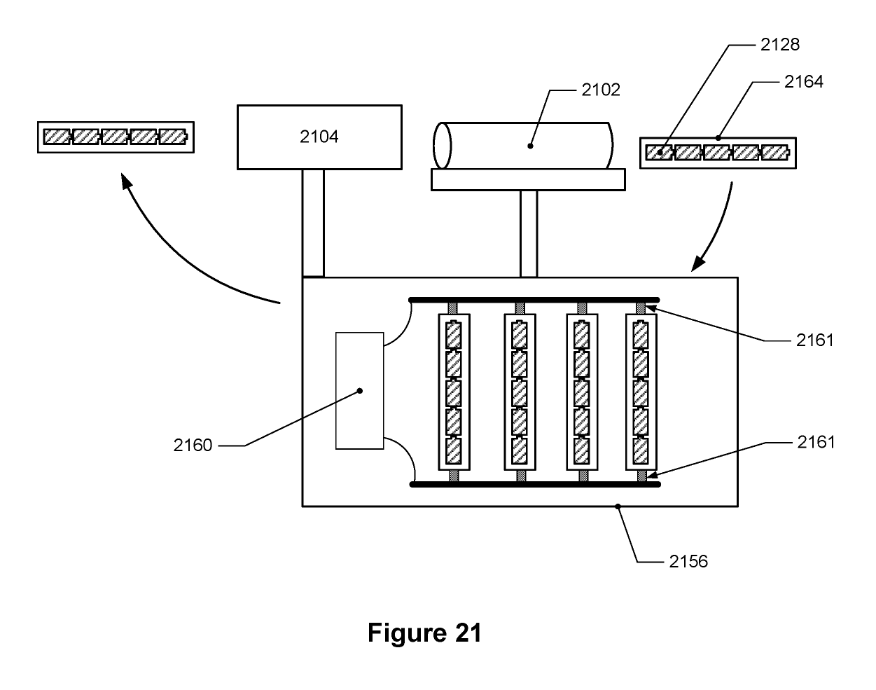

In some implementations, the battery collector may a part of the battery transporter(s) and the battery storage. For example, the battery collector may be a battery collector tube that is configured to receive batteries from the battery holding tube, to be transported to the battery storage, to be located in the battery storage so that the batteries are charged while in the battery collector tube, and to be transported to the battery loader so that charged batteries may be unloaded from the battery collector tube and loaded into the battery loader. FIG. 21 depicts another example schematic of a partial battery exchange system; this is similar to FIG. 15 and is intended as only a representational illustration. As can be seen, the battery collector 2164 is a battery collector tube that is configured to receive batteries from the battery holding tube like described above. For instance, the battery loader 2104 may load charged batteries into the battery holding tube 2102 thereby simultaneously unloading the batteries already in the battery holding tube 2102 and pushing these batteries into the battery collector tube 2164. Once the batteries 2128 are loaded into the battery collector tube 2164, the battery transporter (not shown) may then transport the battery collector tube 2164 to the battery storage 2156; the battery transporter may be a robotic arm or other conveyor-type system like described herein above.

The battery collector tube 2164 may be moved to and positioned within the battery storage 2156 so that the battery charger 2160 may charge the batteries located within the battery collector tube 2164 without removing the batteries from the battery collector tube 2164. The battery collector tube 2164 may have electrical contacts, similar to the battery holding tube described above, that make electrical contact with a battery inside the battery collector tube 2164 so an electrical circuit may be completed between the batteries in the battery collector tube 2164. The battery charger 2160 may have multiple slots or positions that are configured to receive and charge the batteries in a battery collector tube 2164, such as by having corresponding electrical contact points that electrically connect with the electrical connection points on the battery collector tube 2164 and complete an electrical circuit with the battery charger 2160. As seen in FIG. 21, the battery charger 2160 includes four slots that each have a positive and negative electrical connector, 2161 and 2163, respectively, that electrically connect with electrical connection points (not identified) on the battery collector tube 2164.

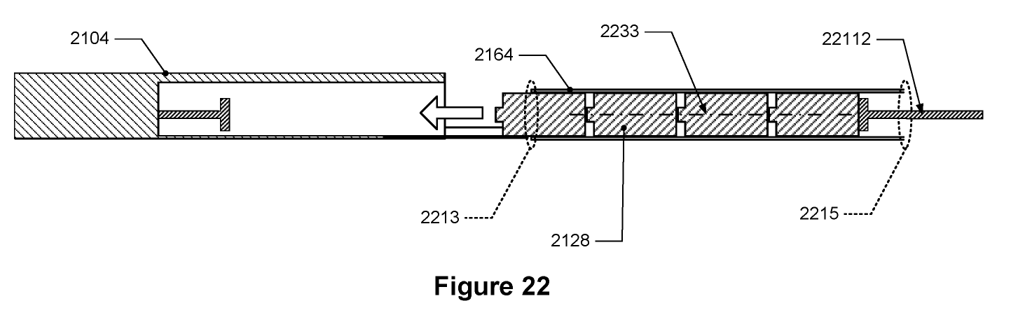

After charging, the batteries inside the battery collector tube 2164 may be loaded into to the battery loader 2104. To do so, the system may transport the battery collector tube out of the battery storage and cause the batteries within the battery collector tube to be moved into the battery loader. For example, similar to the battery loading and unloading described above (e.g., like from the battery loader to the battery holding tube but, here, from the battery collector tube to the battery loader), the system may cause the battery collector tube 2164 to be aligned with the battery loader 2104 so that batteries may move through the battery collector tube 2164 and into the battery loader. FIG. 22 depicts an example loading of a battery loader. As can be seen, the battery collector tube 2164 is aligned with the battery loader 2104 and is configured such that batteries 2128 may be pushed by a battery pusher 22112 along the center axis of the battery collector tube 2233 through the battery collector tube 2164 and into the battery loader 2104. The battery collector tube 2164 may also have a first end 2213 with a first opening and a second end 2215 with a second opening to facilitate this movement; the battery collector tube 2164 may additionally have covers like described above with respect to the battery holding tube.

In some embodiments of the present disclosure, a system may include a plurality of battery exchange stations which are configured to exchange batteries of one or move UAVs, like mentioned above, which may enable a UAV to travel distances farther than if it must return to its point of origin for recharging, and it may reduce the time the UAV may be idle while charging. The plurality of battery exchange stations may be located at different geographic locations so that UAVs may travel between and around stations, similar to gas stations located throughout a city or along a highway.

The system may include features and utilize techniques to track the location of batteries within the system, track which batteries are located in which UAV, track the location of the UAVs, and track the charge provided to each battery within the system. For example, the system may be configured to track which batteries have been loaded into a particular UAV, the location of that UAV, the location of where the batteries are unloaded from that UAV, and the charge consumed by that UAV. A company that owns or operates that UAV may be financially charged for the use of a battery exchange station as well as for the charge used by that UAV. Additionally, the UAVs of the present system may include one or more standardized battery holding tube, like described above, so that any UAV compatible with the system may have its batteries exchanged at any battery exchange station.

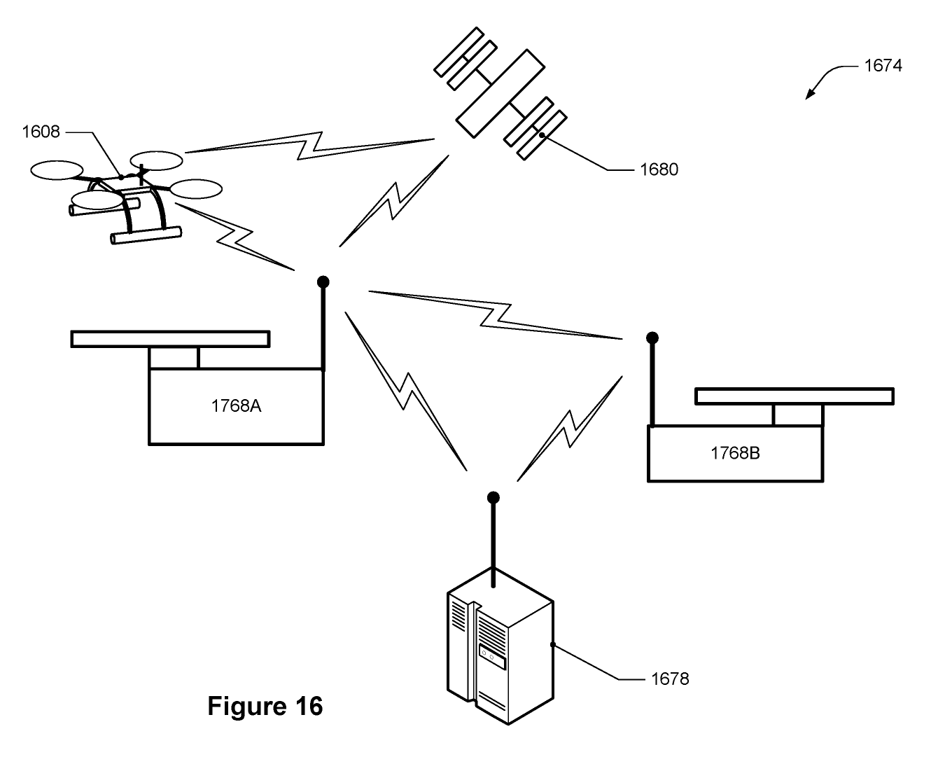

FIG. 16 depicts an example system including a plurality of battery exchange stations. The system 1674 shows two battery exchange stations 1768A and 1768B, a database 1678, and a UAV 1608. The UAV 1608 is in wireless communication with the battery exchange station 1768A and a GPS satellite 1680, the battery exchange stations 1768A and 1768B are in wireless communication with each other and with the database 1678, and battery exchange station 1768A is in communication with GPS satellite 1680. This wireless communication enables the UAV to alert a battery exchange station 1768 of its arrival and request for a battery exchange, enables the UAV to locate the battery exchange stations, enables the battery exchange stations to transmit various information to the database which may include maintenance and service information, numbers of batteries in the battery storage, number of UAVs that have undergone a battery exchange over a particular time period, charging information of each battery in the battery storage, and the number of batteries loaded into UAVs (including into which UAVs, such as those operated by Company A and Company B).

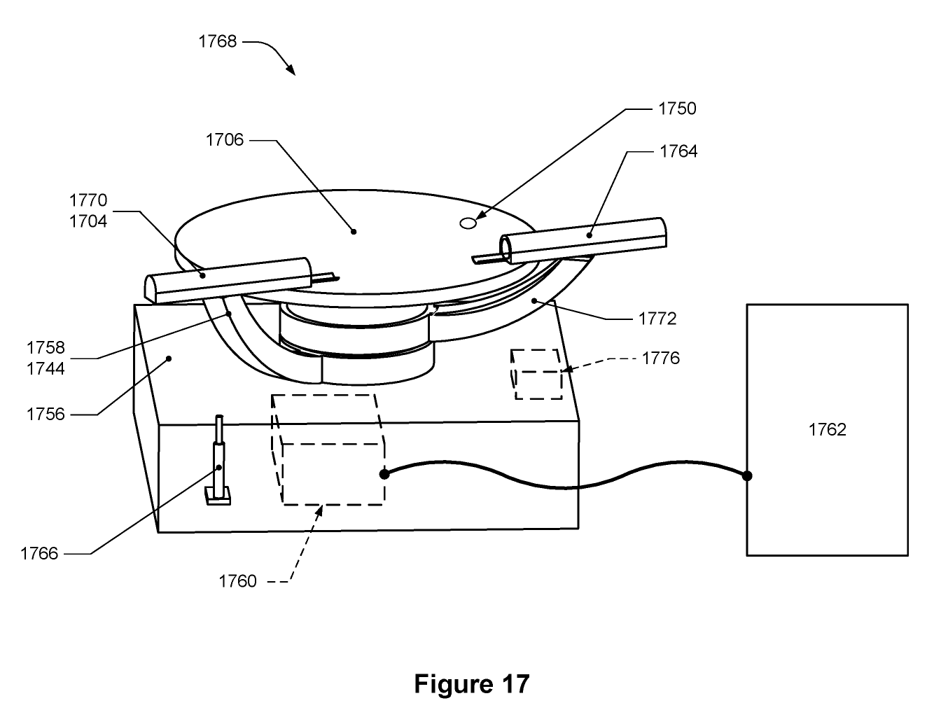

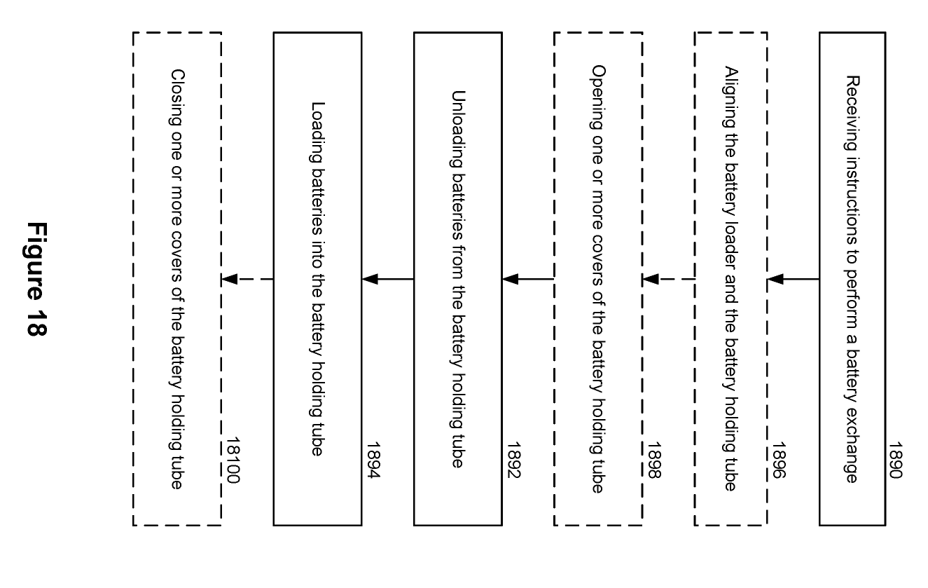

Each battery exchange station may include some or all of the features of battery exchange systems described herein above with respect to FIGS. 1-14; the battery exchange systems described therein may therefore be considered a battery exchange station. FIG. 17 depicts an example battery exchange station which is similar to the battery exchange system depicted in FIG. 1. As can be seen, the battery exchange station 1768 may include a landing zone 1706, a battery exchanger 1770 (like battery loader 104) configured to load batteries into and to unload batteries from the UAV, a battery storage 1756 configured to store one or more batteries for the UAV, a first battery transporter 1758 (including the support arm 1744), a battery charger 1760 (shown representationally as a dashed box within battery storage 1756), one or more photovoltaic cells 1762 configured to supply power to the battery charger 1760, a battery collector 1764, and a second battery transporter 1772 (which may be another support arm like 1744); these elements are like those described herein above, including the system of FIG. 15.

The system may be configured such that each battery exchange station is able to communicate with a UAV, using a communications mechanism configured to communicate with the UAV, to facilitate exchanging the batteries of the UAV, including enabling the UAV to locate the battery exchange station. The communications mechanism may include an antenna 1766 and is configured to communicate via any suitable wireless or wired communication method and/or protocol, such as via radio waves, Bluetooth, or satellite. The communications mechanism of each battery exchange station may also be configured to communicate with other battery exchange stations and other electronic devices, such as a mobile device, a computer, a GPS satellite, and the database, via wired and/or wireless connections and protocols.

Each battery exchange station may also include a controller 1776 which may be configured to control the battery exchanger 1770, the first battery transporter 1758, the battery charger 1760, the second battery transporter 1772, and the communications mechanism. Controller 1776 may include a memory and one or more processors that may store control logic for controlling aspects of the battery control stations, such as causing the battery exchanger 1770 to unload and load batteries into and from the UAV in the loading zone 1706, causing the first battery transporter 1758 to transport one or more batteries from the battery storage 1756 to the battery exchanger 1770, causing the second battery transporter 1772 to transport one or more batteries from the battery collector 1764 to the battery storage 1756, and causing the battery charger 1760 to charge one or more batteries in the battery storage 1756.

The controller 1776 may include at least one memory device, one or more mass storage devices, and one or more processors which may include one or more CPUs, ASICs, general-purpose computer(s) and/or specific purpose computer(s), one or more analog and/or digital input/output connection(s), one or more stepper motor controller board(s), etc. Controller 1776 may also execute machine-readable system control instructions on the processor and system control instructions may include instructions for controlling the battery exchange station as described above and may be configured in any suitable way and may by implemented in software; in other implementations, the instructions may be implemented in hardware—for example, hard-coded as logic in an ASIC (application specific integrated circuit), or, in other implementations, implemented as a combination of software and hardware. In some implementations, system control software may include input/output control instructions for controlling the various parameters described above. In some implementations, there may be a user interface associated with controller 1776. The user interface may include a display screen, graphical software displays, and user input devices such as pointing devices, keyboards, and touch screens.

In some implementations, like described above, the battery exchange station 1768 may also include a sensor 1750 that is configured to detect whether the UAV is in or near the landing zone 1706. The controller 1776 may include control logic for receiving sensor data from the sensor 1750 and determining, based on that sensor data, that the UAV is in the landing zone, and control logic for causing the loading and unloading of the battery holding tube of the UAV based on that sensor data.

Each battery exchange station 1768 of the system may also include a battery tracker that is configured to determine each battery loaded onto the UAV. This may enable the system to track the location of each battery and/or the UAV that possesses that battery. The battery tracker may be of various configurations, such as an RFID reader that reads RFID tags located on each battery or a bar code scanner that reads bar codes located on each battery. The controller 1776 also includes control logic for storing on a memory information associated with the determination of each battery that is loaded onto the UAV (such as the type of battery loaded, the make and model of the battery loaded, the charge level of each battery loaded, the number of batteries loaded, the owner of the battery, the owner of the UAV, the destination of the UAV, and the make and model of the UAV). The controller 1776 may also include control logic for transmitting that information to the database so that this information may be stored and tracked.

The controller 1776 may also include control logic for determining the amount of charge delivered to each battery in the battery storage 1756, and sending to the database 1678 information associated with the amount of charge delivered to each battery in the battery storage 1758. That information may be the amount of charge delivered, the source of the power for that charging (e.g., solar, wind, power grid), the owner of the battery, the owner of the UAV from which the battery was unloaded, an account associated with the UAV from which the battery was unloaded.

The controller 1776 may also be configured to cause diagnostics to be performed of the batteries that are unloaded from the UAV, such as analysis of the charge used and whether that charge is above or below a particular battery usage threshold. For example, in some implementations the controller 1776 may be configured to determine the amount of charge used by each battery from a UAV and whether the battery is losing more charge than should be expected based on the operation diagnostics of the UAV and based on a usage comparison to the other batteries that were located on the UAV. Additionally, such information may be stored on the database and may also be communicated to the account of the owner or operator of that particular UAV.

In some implementations, the system may also include securement or safety features to secure and protect a UAV during inclement weather. For example, when weather conditions may prohibit the safe flight of a UAV, the UAV may land on the landing zone, and the UAV may be secured to the landing zone by a clamp, like described above, to prevent the UAV from being moved during the inclement weather. In some implementations, the landing zone may also include safety features that are configured to protect the UAV from inclement weather, such as a dome or a barrier wall that surrounds some or all of the UAV.

It should also be noted that each battery exchange station, including the battery exchange systems of FIGS. 1-14, may include more than one landing zone such that multiple UAVs may be positioned at that battery exchange station. In such implementations, the battery exchange station may be configured to load and unload batteries of varying sizes into and out of UAVs that may have battery holding tubes of varying diameters and lengths.

In some implementations, various techniques may be utilized by the above systems to perform a battery exchange. FIG. 18 depicts a flowchart of an example technique for performing a battery exchange. In block 1890, instructions are received by a battery exchange station to perform a battery exchange of a battery holding tube on a UAV. The instructions may be received from a sensor that has detected the presence of a UAV on the landing zone, or from the UAV, or both. In block 1892, the one or more batteries that are located within the battery holding tube are unloaded and in block 1894, one or more batteries are loaded into to the battery holding tube, like described above. The loading and unloading techniques may vary and may even occur simultaneously, like discussed above in FIGS. 6-14.

In optional block 1896, an alignment may occur between a battery loader and the battery holding tube, like also described above. For example, this may involve moving the battery loader into alignment with the battery holding tube while the battery holding tube remains stationary. In another optional block 1898, one or more of the covers of the battery holding tube may be opened in order to unload the batteries and similarly in optional block 18100, one or more covers of the battery holding tube may be closed after loading the batteries into the battery holding tube, like described above.

In some implementations, the battery exchange technique may also include those actions and descriptions included above, such as receiving and transporting batteries from the battery holding tube to a battery storage, charging batteries in the battery storage, transporting batteries from the battery storage to the battery holding tube, communicating with the UAV to receive information from the UAV (such as instructions to perform a battery exchange) and to transmit information to the UAV (such as whether the landing zone is available), communicating with a database to transmit and receive information (such as the owner of the UAV, the owner of the batteries, the number of batteries loaded into and unloaded from the UAV, the charge provided to batteries loaded into and unloaded from the UAV, and the power source of the charge provided to the batteries; this information may be collected and stored by the battery exchange station), and communicating with other battery exchange stations.

The present invention is neither limited to any single aspect nor implementation, nor to any combinations or permutations of such aspects and implementations. Moreover, each of the aspects of the present invention, or implementations thereof, may be employed alone or in combination with one or more of the other aspects and implementations thereof. For the sake of brevity, many of those permutations and combinations will not be discussed or illustrated separately herein.

1. A system for exchanging batteries of an unmanned aerial vehicle, the system comprising:
a battery holding tube that is located on the unmanned aerial vehicle and that includes a first end with a first opening and a second end with a second opening; and
a battery loader configured to:
cause a cylindrical battery to move into the battery holding tube through the first opening of the first end in a direction parallel to the center axis of the battery holding tube, wherein the center axis of the cylindrical battery is parallel to the center axis of the battery holding tube, and
cause the cylindrical battery to move out of the battery holding tube through the second opening of the second end in a direction parallel to the center axis of the battery holding tube, wherein the center axis of the cylindrical battery is parallel to the center axis of the battery holding tube.

2. The system of claim 1, further comprising an aligner that is configured to cause the battery holding tube and the battery loader to be aligned such that the center axis of the cylindrical battery is substantially coaxial with the center axis of the battery holding tube when the battery loader causes the cylindrical battery to move into the battery holding tube through the first opening of the first end in a direction parallel to the center axis of the battery holding tube.

3. The system of claim 2, wherein the aligner is further configured to cause the battery loader to move with respect to the battery holding tube to cause the battery holding tube and the battery loader to be aligned.

4. The system of claim 1, wherein the battery loader is further configured to cause the cylindrical battery to move through the battery holding tube in a direction parallel to the center axis of the battery holding tube, wherein the center axis of the cylindrical battery is parallel to the center axis of the battery holding tube.

5. The system of claim 1, further comprising:
a landing zone configured to receive the unmanned aerial vehicle; and
a clamp, wherein the clamp is configured to fix the position of the battery holding tube with respect to the landing zone.

6. The system of claim 5, further comprising a sensor configured to detect the present of an unmanned aerial vehicle in the landing zone, wherein the battery loader is configured to cause, when the unmanned aerial vehicle is detected in the landing zone, the cylindrical battery to move into the battery holding tube through the first opening of the first end in a direction parallel to the center axis of the battery holding tube, wherein the center axis of the cylindrical battery is parallel to the center axis of the battery holding tube.

7. The system of claim 1, wherein the battery holding tube further includes a first cover and a second cover, wherein:
the first cover has a first inner surface having a first electrical contact, and is configured to be in a first open position and a first closed position,
in the first open position, the first cover does not obstruct the first opening of the battery holding tube,
in the first closed position, the first cover is secured to the battery holding tube such that the first cover overlaps with the first opening when viewed along the center axis of the battery holding tube and the first electrical contact is configured to electrically contact a cylindrical battery inside the battery holding tube,
the second cover has a second inner surface having a second electrical contact, and is configured to be in a second open position and a second closed position,
in the second open position, the second cover does not obstruct the second opening of the battery holding tube, and
in the second closed position, the second cover is secured to the battery holding tube such that the second cover overlaps with the second opening when viewed along the center axis of the battery holding tube and the second electrical contact is configured to electrically contact a cylindrical battery inside the battery holding tube.

8. The system of claim 7, further comprising a cover actuator that is configured to:
cause the first cover to move between the first closed position and the first open position, and
cause the second cover to move between the second closed position and the second open position.

9. The system of claim 1, wherein the battery holding tube is a landing skid of the unmanned aerial vehicle.

10. The system of claim 9, further comprising a second battery holding tube that is another landing skid of the unmanned aerial vehicle and that includes a third end with a third opening and a fourth end with a fourth opening, wherein the battery loader is further configured to:
cause the cylindrical battery to move into the second battery holding tube through the third opening of the third end in a direction parallel to the center axis of the second battery holding tube, wherein the center axis of the cylindrical battery is parallel to the center axis of the second battery holding tube, and
cause the cylindrical battery to move out of the second battery holding tube through the fourth opening of the fourth end in a direction parallel to the center axis of the second battery holding tube, wherein the center axis of the cylindrical battery is parallel to the center axis of the second battery holding tube.

11. The system of claim 1, wherein the battery loader is configured to cause a plurality of cylindrical batteries to move into the battery holding tube through the first opening of the first end in a direction parallel to the center axis of the battery holding tube, wherein the center axis of each of cylindrical batteries is parallel to the center axis of the battery holding tube.

12. The system of claim 1, further comprising:
a battery storage that is configured to hold a plurality of cylindrical batteries, and
a battery transporter that is configured to move a cylindrical battery from the battery storage to the battery loader.

13. The system of claim 12, further comprising:
a battery charger configured to charge one or more cylindrical batteries, and
one or more photovoltaic cells that are configured to supply power to the battery charger.

14. The system of claim 12, wherein the battery charger is further configured to charge one or more cylindrical batteries held in the battery storage.

15. The system of claim 12, further comprising a battery collector that is configured to receive the cylindrical battery that is caused to move out of the battery holding tube through the second opening of the second end, wherein the battery transporter is further configured to move the cylindrical battery from the battery collector to the battery charger.

16. A system comprising:
a plurality of battery exchange stations for an unmanned aerial vehicle, wherein each battery exchange station includes:
a landing zone configured to receive the unmanned aerial vehicle;
a battery exchanger configured to unload batteries from and to load batteries into the unmanned aerial vehicle;
a battery storage configured to store one or more batteries for the unmanned aerial vehicle;
a first battery transporter configured to transport one or more batteries from the battery storage to the battery exchanger;
a battery charger configured to charge one or more batteries in the battery storage;
one or more photovoltaic cells configured to supply power to the battery charger;
a battery receiver configured to receive batteries unloaded from the unmanned aerial vehicle;
a second battery transporter configured to transport one or more batteries from the battery receiver to the battery storage;
a communications mechanism configured to communicate with the unmanned aerial vehicle; and
a controller configured to control the battery exchanger, the first battery transporter, the battery charger, the second battery transporter, and the communications mechanism, wherein the controller includes control logic for:
causing the battery exchanger to unload batteries from an unmanned aerial vehicle in the loading zone,
causing the battery exchanger to load batteries into an unmanned aerial vehicle in the loading zone,
causing the first battery transporter to transport one or more batteries from the battery storage to the battery exchanger,
causing the second battery transporter to transport one or more batteries from the battery collector to the battery storage, and
causing the battery charger to charge one or more batteries in the battery storage.

17. The system of claim 16, wherein:
each battery exchange station further includes a sensor configured to detect whether the unmanned aerial vehicle is in the landing zone, and
each controller further includes control logic for determining, based on one or more of sensor data from the sensor and communications data from the unmanned aerial vehicle, that the unmanned aerial vehicle is in the landing zone.

18. The system of claim 16, wherein:
each battery exchange station further includes a battery tracker that is configured to determine each battery loaded onto the unmanned aerial vehicle, and
each controller further includes a memory and further includes control logic for storing on the memory information associated with the determination of each battery loaded onto the unmanned aerial vehicle.

19. The system of claim 18, further comprising a database, wherein each controller further includes control logic for sending to the database, using the communications mechanism, the information associated with the determination of each battery loaded onto the unmanned aerial vehicle.

20. The system of claim 19, wherein each controller further includes control logic for:
determining the amount of charge delivered to each battery in the battery storage, and
sending to the database, using the communications mechanism, information associated with the amount of charge delivered to each battery in the battery storage.

21-28. (canceled).
